(19) United States
(12) Patent Application Publication
(10) Pub. No.: US 2010/0295337 A1
(43) Pub. Date: Nov. 25, 2010

(54) SIMULTANEOUS SINGLE RAIL MOVEMENT SYSTEM FOR A VEHICLE DOOR II

(76) Inventors: Adrian Elliott, Dearborn, MI (US); Jason Falenski, Berkley, MI (US); David Lechkun, Shelby Township, MI (US); Craig Blust, Oakland, MI (US)

Correspondence Address: PRICE, HENEVELD, COOPER, DEWITT & LITTON, LLP;FORD GLOBAL TECHNOLOGIES, LLC, 695 KENMOOR S.E., P. O. BOX 2567, GRAND RAPIDS, MI, 49501-2567, US

(21) Appl. No.: 12/471,131

(22) Filed: May 22, 2009

(51) Int. Cl. B60J 5/00

(52) U.S. Cl. 296/202

(57) ABSTRACT

A simultaneous single rail movement system for a vehicle door includes a first hinge arm, a second hinge arm, a rail and a guide track. The first hinge arm is pivotally mounted to a vehicle body structure at the body end. The second hinge arm is pivotally mounted to a vehicle body structure. The rail is operatively configured to receive the slide member. The slide member is pivotally mounted to the slide member region of the first hinge arm and the door end of the second hinge arm. The guide track receives the guide track region of the first hinge arm.

### BACKGROUND

The present disclosure relates generally to hinge and slide devices, and more particularly, to such a device for vehicle doors.

Sliding door structures are generally implemented on vehicles to reduce the door swing distance from the vehicle body; to allow for better ingress and egress into or from a vehicle; and to provide more efficient use of vehicle space. This type of design may be particularly helpful when a user is parking a vehicle in a confined area where there is little available room for door swing.

In a traditional sliding door structure, guide rails are generally included at the roof or cant rail and the rocker or sill as well as adjacent to a vehicle body class A surface. It is to be understood that the class A surface of a vehicle is the exterior area of the vehicle that is visible. The guide rail on the class A surface is generally configured as a linear track just below the side window of a vehicle. In addition, such vehicles generally also implement a separate curved guide track on the vehicle body at the sill/rocker and/or side rail or cant rail to guide the sliding door into the closed position against the vehicle body. To open a traditional sliding door, the sliding door is projected in a vehicle exterior direction along the curved guide track, and then the sliding door is translated along a separate linear guide track to a fully opened position. To close the sliding door, the sliding door is moved to the curved guide track (upon leaving the separate linear guide track) until the sliding door is pulled inward toward the vehicle.

However, a traditional sliding door movement does coincide with the curved shape of the guide rail once it transitions from the linear track to the curved track resulting in a two step operation for opening and closing the sliding door, thereby resulting in disrupted motion as the vehicle door is opened and closed.

Furthermore, as indicated above, the traditional sliding door movement system requires guide tracks at the three different locations on the vehicle. It is to be understood that implementation of a sliding door on sedan vehicles, sports coupes, trucks, etc. may in some instances provide additional challenges due to their specific and varied body architectures. As such, sliding door systems are traditionally implemented on larger vehicles such as vans and/or minivans, which have ample area to mount sliding systems on the vehicle body itself.

### SUMMARY

A simultaneous single rail movement system for a vehicle door is provided according to the non-limiting exemplary embodiment(s) disclosed herein. The simultaneous movement system includes a first hinge arm, a second hinge arm, a rail and a guide track. The first hinge arm includes a body end wherein the first hinge arm is pivotally mounted to a vehicle body structure at the body end. The first hinge arm further includes a slide member region, and a guide track region, and is pivotally mounted to the slide member at the slide member region. The second hinge arm includes a body end and a door end. The second hinge arm is pivotally mounted to a vehicle body structure at the body end of the second hinge arm. The second hinge arm is pivotally mounted to a slide member at the door end of the second hinge arm. The rail is mounted to a vehicle door. The rail is operatively configured to receive the slide member. The slide member is pivotally mounted to the slide member region of the first hinge arm and the door end of the second hinge arm. The guide track is disposed proximate to the rail and operatively configured to receive the guide track region of the first hinge arm. The guide track includes a substantially curved portion and a substantially linear portion. The guide track is operatively configured to facilitate continuous and smooth movement of the door upon opening and upon closing.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is an isometric view of a first embodiment of a simultaneous movement single rail door system (vehicle door and vehicle body shown in phantom) when the system is in the closed position;

FIG. 1B is a plan view of a first embodiment of a simultaneous movement single rail door system (vehicle door removed and vehicle body shown in phantom) when the system is in the closed position

FIG. 2 is an enlarged partial isometric view of a door end of an inboard hinge arm (and guide track shown in phantom) of the present disclosure;

FIG. 3 is an enlarged partial isometric view of the door end of the inboard hinge arm of FIG. 1 where the guide track is removed and the first and second regions of the inboard hinge arm are shown;

FIG. 4 is an isometric view of a first embodiment of the present disclosure (vehicle door and vehicle body shown in phantom) when the door is in its initial opening state;

FIG. 5 is an isometric view of a first embodiment of the present disclosure (vehicle door and vehicle body shown in phantom) when the door is in its first progressively opening state;

FIG. 6A is an isometric view of a first embodiment of the present disclosure (vehicle door and vehicle body shown in phantom) when the door is in its second progressively opening state;

FIG. 6B is an plan view of a first embodiment of the present disclosure (vehicle door and vehicle body shown in phantom) when the door is in its second progressively opening state;

FIG. 7A is an isometric view of a first embodiment of the present disclosure (vehicle door and vehicle body shown in phantom) when the door is in its fully open state;

FIG. 7B is a plan view of a first embodiment of the present disclosure (vehicle door and vehicle body shown in phantom) when the door is in its fully open state.

FIG. 8 is an isometric view of a second embodiment of the simultaneous movement single rail door system (vehicle door and vehicle body shown in phantom) when the door is in the closed position.

FIG. 9 is an isometric view of a second embodiment of the simultaneous movement single rail door system (vehicle door and vehicle body shown in phantom) when the door is in the initially opening position.

FIGS. 10 and 11 are isometric views of a second embodiment of the simultaneous movement single rail door system of FIG. 8 (vehicle door and vehicle body shown in phantom) when the door is in its progressively opening states

FIG. 12 is an isometric view of a second embodiment of the simultaneous movement single rail door system of FIG. 8 (vehicle door and vehicle body shown in phantom) when the door is in its fully open state.

### DETAILED DESCRIPTION

Embodiment(s) of the present disclosure include a simultaneous movement single rail door system 10 wherein the exterior sheet metal surface of the vehicle (not shown) is not disrupted with a door track for the sliding door system 10. The present disclosure allows for simultaneous sliding and articulating of a vehicle door 12 where the packaging and/or mounting area of such system 10 on a vehicle may be limited. The simultaneous movement single rail system 10 implements both a rail 48 and a guide track 44 in combination with the door hinge arms 14, 16 to substantially and advantageously overcomes at least the potential drawbacks noted in the background above.

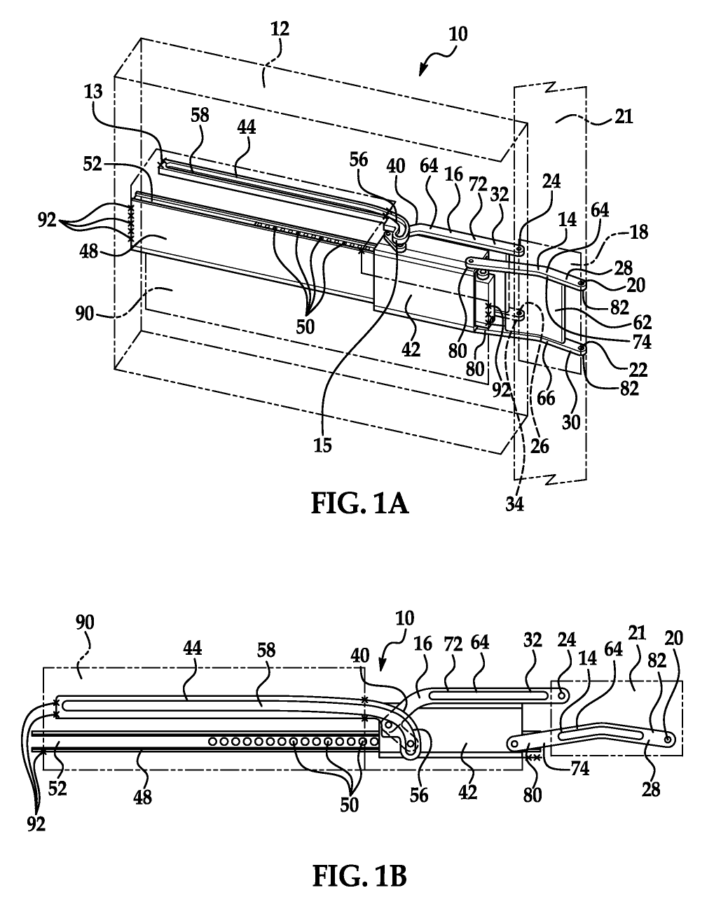

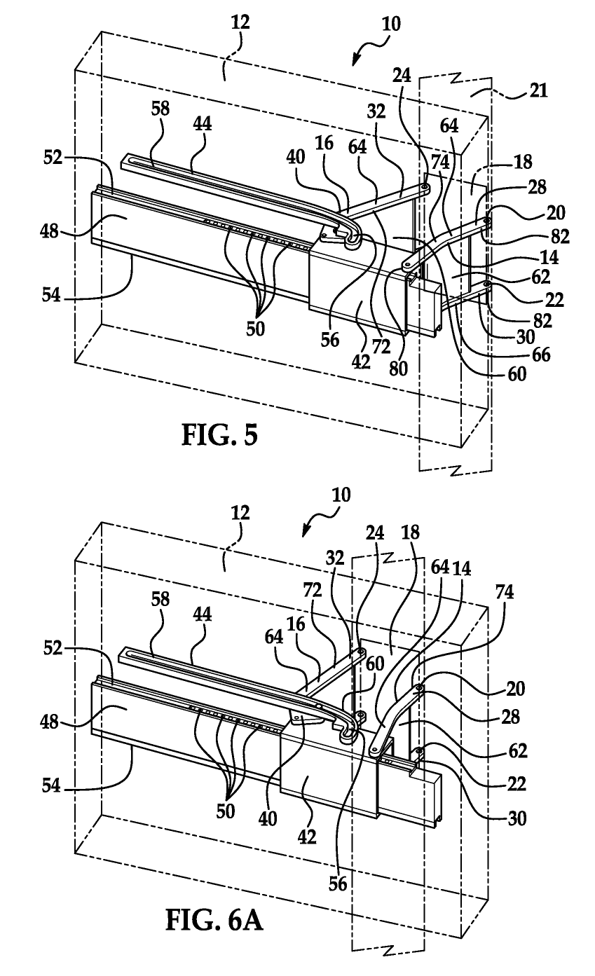

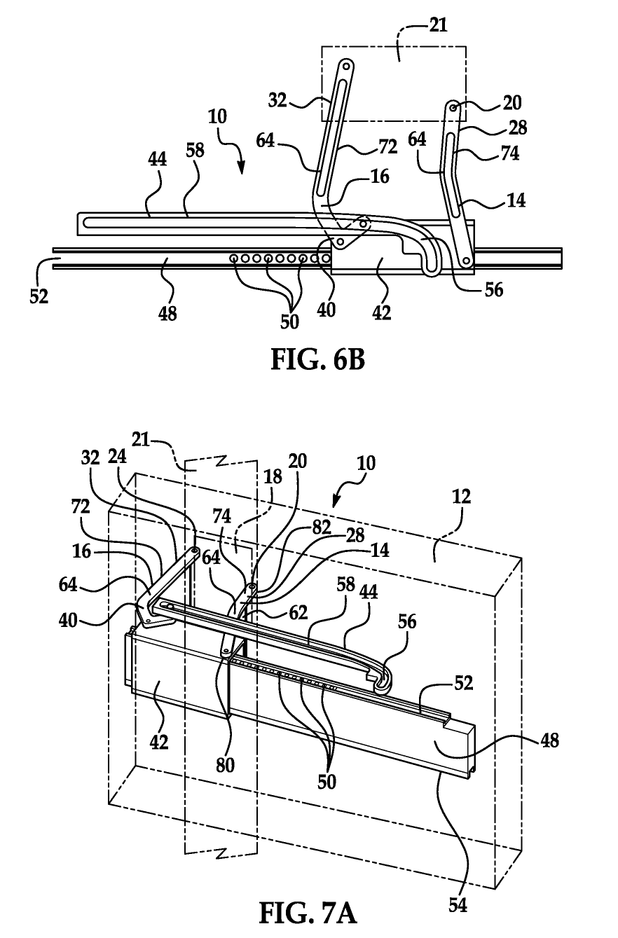

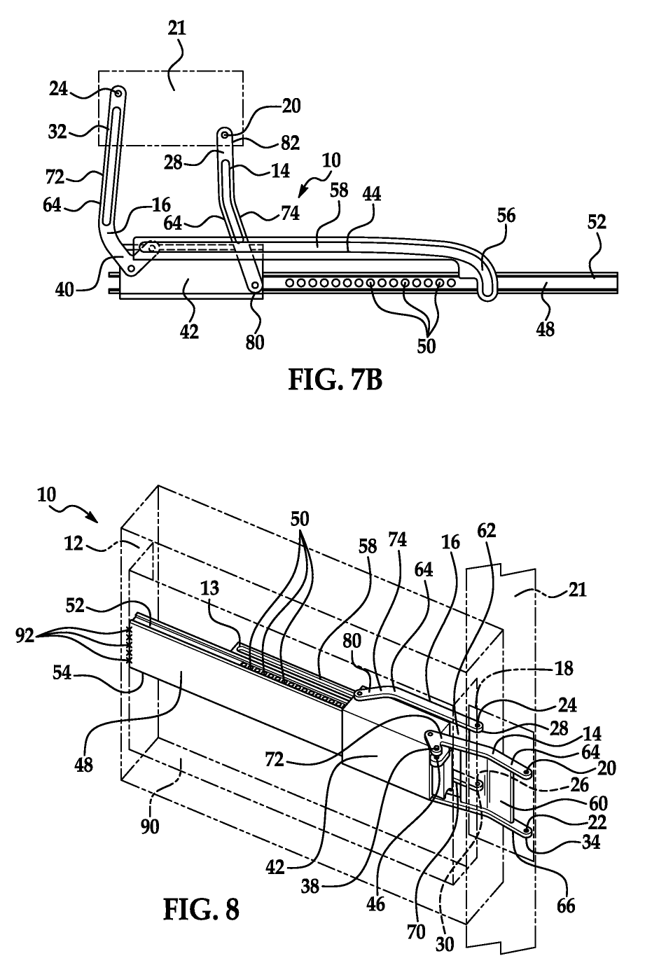

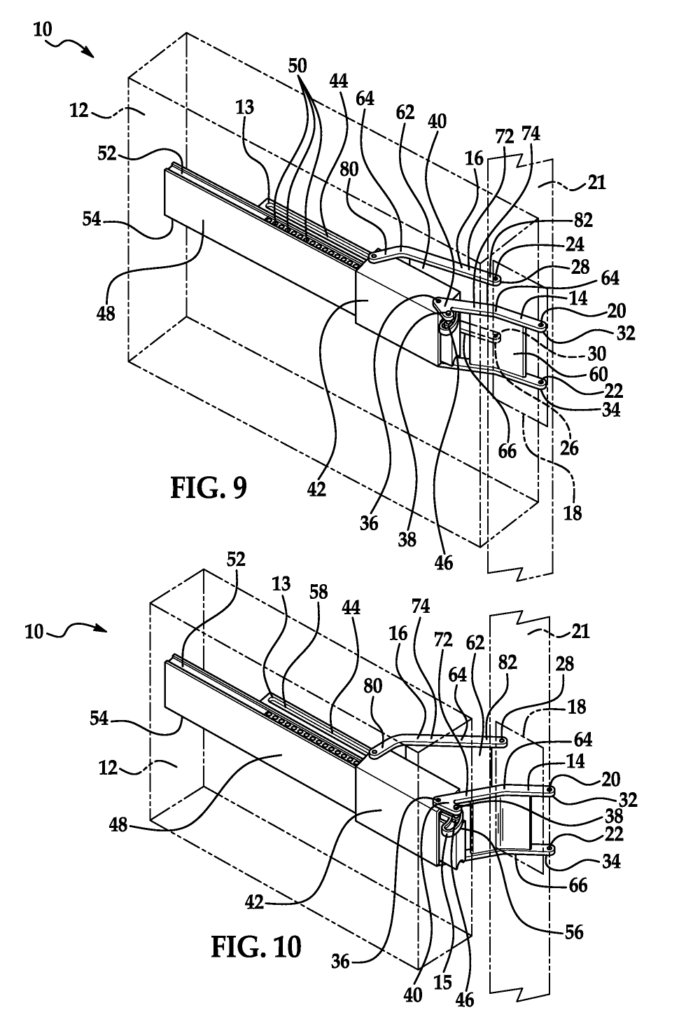

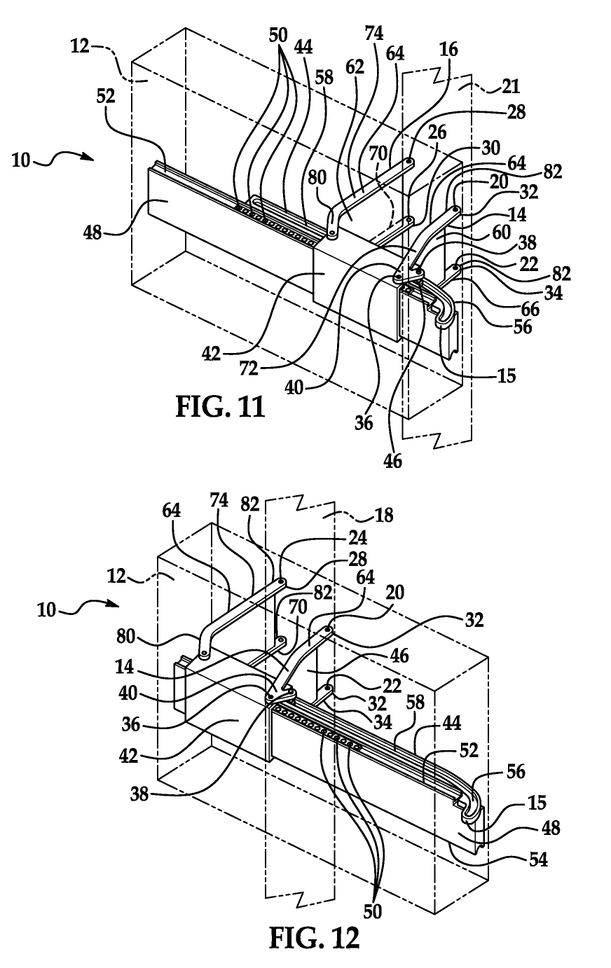

As indicated, the simultaneous movement system 10 allows for simultaneous articulation and translation of the vehicle door 12 which may be mounted on a single body side member (shown as C-pillar 21 in FIGS. 1-12). Moreover, the simultaneous movement system 10 for a door 12 of the present disclosure is robust in design and may involve fewer components than traditional sliding door systems.

Referring now to FIGS. 1-7B together, a simultaneous movement single rail door system 10 for a vehicle door 12 may generally be mounted onto a vehicle body structure such as, but not limited to a C-pillar 21. As shown in FIGS. 1-7B, and described in greater detail below, in order to facilitate ingress and egress into and from a vehicle (not shown) such as, but not limited to, a sedan or a sports coupe, a simultaneous movement single rail door system 10 is provided. The simultaneous movement single rail door system 10 may allow smooth opening and/or closing of a door 12 independent of another adjacent structure or door (not shown) being open or closed.

As shown in FIGS. 1-7, a simultaneous movement single rail door system 10 may be mounted in a single discrete location (such as mounting plate 18) on the vehicle structure or vehicle pillar 21 given that the inboard hinge arm 16 and the outboard hinge arm 14 are in close proximity to one another. This arrangement is useful in vehicle body structures given that there is little available space to mount such a door slide system 10 on a vehicle. As indicated, the simultaneous single rail door slide system 10 may include an inboard hinge arm 16 and an outboard hinge arm 14. It is to be understood that this arrangement of the inboard hinge arm 16 and outboard hinge arm 14 is a four bar link arrangement. It is further to be understood that the term, inboard, refers to a component, such as the non-limiting example of inboard hinge arm 16 that is disposed closer to the interior of the vehicle (not shown) when the door 12 is in a closed position when that component is compared relative to an outboard component such as outboard hinge arm 14. It is further to be understood that the term, outboard, refers to a component that is disposed closer to the exterior of the vehicle (not shown). A non-limiting example of an outboard member is the outboard hinge arm 14 that is disposed closer to the exterior of the vehicle relative to the inboard hinge arm 16 when the door 12 is in the closed position.

With reference to FIGS. 1A-7B, outboard hinge arm 14 is pivotally mounted to the vehicle body structure (shown as vehicle pillar 21) at pivot joints 20, 22 at body ends 28, 30 of outboard hinge arm 14. Inboard hinge arm 16 is also pivotally mounted to vehicle pillar 21 or the vehicle body structure at pivot joints 24, 26 at body ends (shown as 32, 34 in FIGS. 1A-7B) of inboard hinge arm 16. The outboard hinge arm 14 and the inboard hinge arm 16 may be pivotally mounted on a single mounting plate 18 or bracket. This allows for improved packaging capability where the surface area for mounting the hinge system of the sliding door 12 is reduced given that the mounting of the door system is effected at body ends 28, 30, 32, 34 of the inboard hinge arm 16 and outboard hinge arm 14.

Moreover, the present disclosure provides for improved vehicle aesthetics given that this door slide system 10 does not require any guide tracks to be placed on the exterior sheet metal surface of a vehicle. As shown in FIGS. 1-12, the rail 48 and the guide track 44 are housed within the vehicle door 12. Further, there is no concern for any exterior guide track becoming blocked with outdoor debris given that the guide track 44 and rail 48 are located interior to the vehicle and the vehicle door 12. In the present disclosure, the rail 48 and the guide tracks 44 are absent from the exterior of the vehicle (not shown).

It is to be understood that the terms regions and points are being used alternatively in that both terms (points and regions) are to be understood to be small, discrete areas on a member intended for a particular use. Inboard hinge arm 16 is operatively configured to include at least two (regions or) points 36, 38 proximate to the door end 40 of inboard hinge arm 16. Upper inboard hinge arm 16 may be pivotally connected to slide member 42 at inboard hinge arm's first (region or) point 36 and slidably engaged with guide track 44 at upper inboard hinge arm's second (region or) point 38. It is to be understood that each of the upper portion 64 and lower portion 66 of the inboard hinge arm 16 respectively may have such (regions or) points 36, 38. It is further to be understood that (regions or) points 36, 38 may exist on upper portion 64 of inboard hinge arm 16, on the lower portion 66 of inboard hinge arm 16 in the alternative), or on both. Second (region or) second point 38 may include a one piece tab 46, projection, roller or pin-like structure which fits within a surface of guide track 44 as shown in the non-limiting examples of FIGS. 1-7 to guide the door 12 as it articulates and translates relative to the pillar 18 or vehicle body structure member.

As a non-limiting example, tab or projection 46 may be integral with inboard hinge arm 16 as shown in FIGS. 1-7. It is also to be understood that a nut and bolt (not shown) or any suitable fastening means may affix tab or projection 46 to second (region or) point 38 on inboard hinge arm 16.

As shown in FIGS. 1-7, simultaneous movement single rail door system 10 includes rail 48 mounted to vehicle door 12. Guide track 44 may include abutments 13,15 integral with the track configuration in order to define the limit to which the door 12 may travel relative to the pillar 21. In two non-limiting examples, rail 48 and guide track 44 may be mounted to a door inner panel (shown as 90 in FIGS. 1A, 1B, 4A, 8) and/or a door hardware system such as a latch (not shown) via any suitable fastening means, including but not limited to mechanical fasteners (not shown), welds 92, press-fitting, interlocking, other suitable joining methods, or combinations thereof.

Rail 48, is operatively configured to receive slide member 42. In the non-limiting example shown in FIGS. 1-7, slide member 42 has a sleeve-like configuration which receives the rail 48. Therefore, slide member 42 as shown in FIG. 1 is one non-limiting example in which one may implement a sliding structure along rail 48. In the non-limiting example of FIGS. 1-7, rail 48 may include ball bearings 50 along the upper surface 52 and/or lower surface 54 of the rail 48 to facilitate movement of the sleeve or slide member 42 along rail 48. It is to be understood that ball bearings 50 are a non-limiting example, and other suitable components such as roller bearings (not shown) or a lubricated track (not shown) or the like may be implemented with slide member 42. Moreover, it is also to be further understood that a motor (not shown) may, but is not required to be used to power open and power close the system 10. Slide member 42 may be manufactured using a stamped, roll forming, casting or other suitable manufacturing process.

In order to allow vehicle door 12 to articulate and slide simultaneously and smoothly, guide track 44 is implemented to operate in conjunction with and simultaneously with rail 48. As indicated earlier, guide track 44 is operatively configured to receive second (region or) point 38 on inboard hinge arm 16. The second region 38 or point 38 may further include projection 46 which is operatively configured to be received within guide track 44. Guide track 44 includes a substantially curved portion 56 which smoothly translates to a substantially linear track portion 58 to allow smooth and simultaneous articulation and sliding movement of vehicle door 12 as inboard hinge arm 16, (region or) point 38, and projection 46 travel along guide track 44.

In one non-limiting example, guide track 44 may be mounted on door inner panel (shown as 90 in FIGS. 1A, 1B, 4A, 8). In yet other non-limiting examples, guide track 44 may be mounted on door hardware structures such as the door latch and/or handle system (not shown), or guide track 44 may be integral with the rail 48. Regardless of the attachment arrangement for the guide track 44, guide track 44 may be disposed proximate to the rail 48 as shown in FIGS. 1-7. As shown, the inboard hinge arm 16 of FIGS. 1-7, cooperates with both the rail 49 and the guide track 44 at first region (or slide track region) 36 and second region (or guide track region) 38 (at the door 12 of the vehicle) in order to provide smooth and continuous motion as the door 12 opens and closes.

Moreover, in order to further facilitate smooth cooperation and improved stability between all portions of outboard hinge arm 14, inboard hinge arm 16, and slide member 42, a substantially planar member 60, 62 may be disposed within each outboard hinge arm 14 and inboard hinge arm 16. As shown in FIGS. 1-7, substantially planar member 62 is integral with outboard hinge arm 14 and is disposed between upper portion 64 of outboard hinge arm 14 and lower portion 66 of outboard hinge arm 14. Substantially planar member 60 of inboard hinge arm 16 is also shown in FIGS. 1-7 as being integral with upper portion 64 of inboard hinge arm 16 and lower portion 66 of inboard hinge arm 16. However, it is to be understood that substantially planar members 60, 62 may be welded, mechanically fastened, or interlocked (or otherwise suitably fastened) to the upper portions 64 and lower portions 66 of inboard hinge arm 16 and outboard hinge arm 14.

Referring now to FIGS. 1-12 together, a simultaneous single rail movement system 10 for a vehicle door 12 is provided according to the present disclosure. The simultaneous movement system 10 includes a first hinge arm 72 having a body end 32, 34. The first hinge arm 72 is pivotally mounted to a vehicle body structure 21 at the body ends 32, 34. It is to be understood that the body end of the first hinge arm 72 may be a single end (not shown) or multiple ends shown as 32, 34. Multiple body ends 32, 34 are provided in the FIGS. 1-12 given that the first hinge arm 72 in the non-limiting examples of FIGS. 1-12 includes an upper portion 64 and a lower portion 66.

Referring now to FIG. 3, the first hinge arm 72 includes a slide member region 36 and a guide track region 38. As indicated earlier, it is to be understood that the terms regions and points are being used alternatively in that both terms (points and regions) are to be understood to be small, discrete areas on a member intended for a particular use. As the door 12 opens and closes, the first hinge arm 72 cooperates with both the guide track 44 and the rail 48 through the guide track region 38 and the slide member region 36 respectively.

Referring now to FIGS. 1A and 8, the second hinge arm 74 includes a body end 82 and a door end 80. The second hinge arm 74 is pivotally mounted to a vehicle body structure (shown as C-Pillar 21 in the examples shown in FIGS. 1-12) at the body end 82 of the second hinge arm 74. The second hinge arm 74 is pivotally mounted to a slide member 42 at the door end 80 of the second hinge arm 74. As shown, rail 48 may be mounted to the vehicle door 12 via door inner panel 90 (shown in FIGS. 1A and 8) through mechanical fasteners (not shown) or welds 92 or the like. The rail 48 may be operatively configured to receive the slide member 42. As indicated, the slide member 42 is pivotally mounted to the slide member region 36 of the first hinge arm 72 and the door end 80 of the second hinge arm 74.

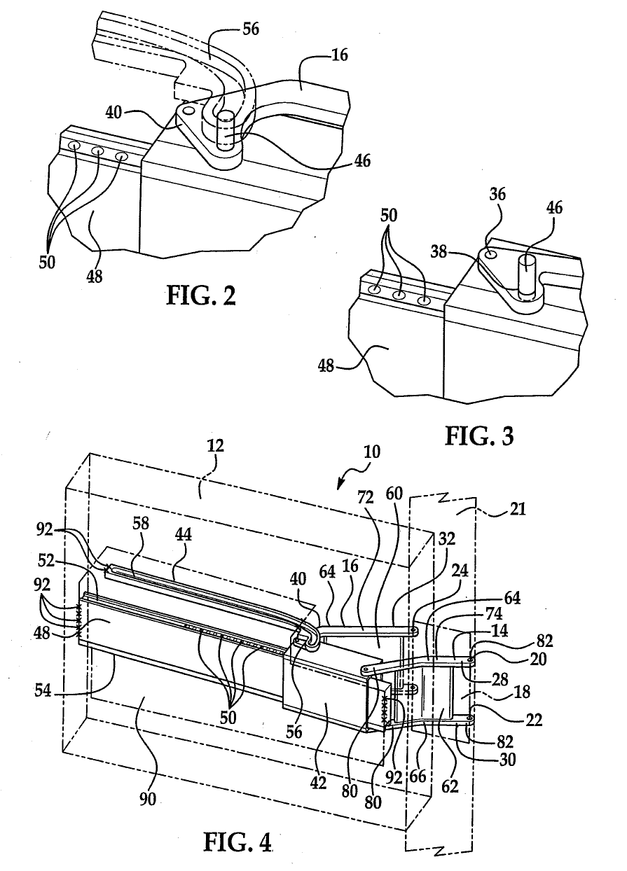

A guide track 44 is also provided proximate to the rail 48. The guide track 44 is operatively configured to receive the guide track region 38 of the first hinge arm 72. The guide track 44 includes a substantially curved portion 56 and a substantially linear portion 58. The guide track 44 is operatively configured to facilitate continuous and smooth movement of the door 12 upon opening and upon closing. The guide track region 38 of the first hinge arm 72 may include a projection (shown as 46 in FIG. 2) integral to the first hinge arm 72 wherein the projection 46 is disposed within the guide track 44. It is also to be understood that the guide track region 38 may include a separate pin or projection (shown as 46 in FIG. 3) affixed to the first hinge arm 72 wherein the pin 46 is disposed within the guide track 44.

The guide track 44 may be integral with the rail 48 as shown in FIGS. 8-12; or the guide track 44 may be affixed to the door 12 via door inner panel 90 (shown in FIGS. 1A and 4) through mechanical fasteners (not shown), welds 92 or the like. In order to facilitate movement between the slide member 42 and the rail 48, a rolling bearing 50 or a plurality of roller bearings 50 may be disposed between the slide member 42 and the rail 48.

As shown in FIGS. 1-12, the guide track 44 is operatively configured with abutments 13, 15 to cooperate with the guide track region 38 (or a projection 46 of guide track region 38) of the first hinge arm 72 to stop movement of the door 12 at a full open position of the door 12.

As shown in FIGS. 1-12, the first hinge arm 72 and the second hinge arm 74 each includes an upper portion 64 and a lower portion 66. A substantially planar member 60, 62 may be disposed between the upper portion 64 and the lower portion 66 thereby allowing stable and continuous movement between the upper portions 64 and lower portions 66 of the first and second hinge arms 72, 74. In one non-limiting example, the substantially planar members 60, 62 may be integral to the upper portion 64 and lower portions 66 of the first and second hinge arms 72, 74. It is also to be understood that the substantially planar members 60, 62 may be affixed to the upper portion and lower portions of the first and second hinge arms 72, 74 via mechanical fasteners, welding, adhesives or the like.

While multiple embodiments have been described in detail, it will be apparent to those skilled in the art that the disclosed embodiments may be modified. Therefore, the foregoing description is to be considered exemplary rather than limiting.

What is claimed is:

1. A simultaneous single rail movement system for a vehicle door, the simultaneous movement system comprising:
a first hinge arm having a body end, the first hinge arm being pivotally mounted to a vehicle body structure at the body end, the first hinge arm having a slide member region and a guide track region;
a second hinge arm having an body end and a door end, the second hinge arm being pivotally mounted to a vehicle body structure at the body end of the second hinge arm, and the second hinge arm being pivotally mounted to a slide member at the door end of the second hinge arm;
a rail mounted to a vehicle door and operatively configured to receive the slide member, the slide member being pivotally mounted to the slide member region of the first hinge arm and the door end of the second hinge arm; and
a guide track proximate to the rail and operatively configured to receive the guide track region of the first hinge arm, the guide track including a substantially curved portion and a substantially linear portion, the guide track being operatively configured to facilitate continuous and smooth movement of the door upon opening and upon closing.

2. The simultaneous movement system of claim 1 wherein the guide track region includes a projection integral to the first hinge arm wherein the projection is disposed within the guide track.

3. The simultaneous movement system of claim 1 wherein the guide track region includes a pin affixed to the first hinge arm wherein the pin is disposed within the guide track.

4. The simultaneous movement system as defined in claim 1 wherein the guide track is integral with the rail.

5. The simultaneous movement system as defined in claim 1, further comprising a ball bearing disposed between the slide member and the rail.

6. The simultaneous movement system as defined in claim 1 wherein the guide track is operatively configured to cooperate with the first hinge arm to stop movement of the door at a full open position of the door.

7. The simultaneous movement system as defined in claim 6 wherein the guide track is operatively configured to cooperate with the guide track region of the first hinge arm to stop movement of the door at a full open position of the door.

8. The simultaneous movement system as defined in claim 1 wherein the guide track region of the first hinge arm includes a projection that is operatively disposed within the guide track.

9. The simultaneous movement system as defined in claim 1 wherein the first hinge arm and the second hinge arm each includes an upper portion and a lower portion, a substantially planar member is disposed between the upper portion and the lower portion.

10. A simultaneous single rail movement system for a vehicle door, the simultaneous movement system comprising:
an inboard hinge arm having an inboard body end, the inboard hinge arm being pivotally mounted to a vehicle body structure at the body end, the inboard hinge arm having a first region and a second region;
an outboard hinge arm having an outboard body end and an outboard door end, the inboard hinge arm being pivotally mounted to a vehicle body structure at the outboard body end;
a rail mounted to a vehicle door and operatively configured to receive a slide member, the slide member being pivotally mounted to the first region of the inboard hinge arm and the outboard door end of the outboard hinge arm; and
a guide track adjacent to the rail and operatively configured to receive the second region of the inboard hinge arm, the guide track including a substantially curved portion and a substantially linear portion, the substantially curved portion of the guide track extending beyond the rail in a longitudinal direction aft of the rail in a manner sufficient to facilitate continuous and smooth movement of the door upon opening and upon closing.

11. The simultaneous movement system as defined in claim 10 wherein the guide track is integral with the rail.

12. The simultaneous movement system as defined in claim 10 wherein the second region includes a tab which is operatively configured to slide within the guide track.

13. The simultaneous movement system as defined in claim 12 wherein the tab is mechanically fastened to the outboard hinge arm.

14. The simultaneous movement system as defined in claim 10 wherein the second region includes a projection integral with the inboard hinge arm, the projection being operatively configured to slide within the guide track.

15. The simultaneous movement system as defined in claim 10, further comprising a ball bearing disposed between the slide member and the rail.

16. The simultaneous movement system as defined in claim 10 wherein the guide track is operatively configured to cooperate with the inboard hinge arm to stop movement of the door at a full open position of the door.

17. The simultaneous movement system as defined in claim 16 wherein the guide track is operatively configured to cooperate with the second region of the inboard hinge arm to stop movement of the door at a full open position of the door.

18. The simultaneous movement system as defined in claim 17 wherein the second region of the inboard hinge arm includes a projection that is operatively disposed within the guide track.

19. The simultaneous movement system as defined in claim 10 wherein the inboard hinge arm and the outboard hinge arms each includes an upper portion and a lower portion and wherein a substantially planar member is disposed between the upper portion and the lower portion.
